(19) United States
(12) Patent Application Publication
(10) Pub. No.: US 2023/0299643 A1
(43) Pub. Date: Sep. 21, 2023

(54) ROTATING MACHINE WITH COOLING FAN

(71) Applicant: SAFRAN POWER USA, LLC, Twinsburg, OH (US)

(72) Inventors: Sachin Aggarwal, Twinsburg, OH (US); Steven McDaniel, Twinsburg, OH (US); Eric Kline, Twinsburg, OH (US); Bryan Mackulin, Twinsburg, OH (US)

(21) Appl. No.: 18/018,640

(22) PCT Filed: Jul. 31, 2020
(86) PCT No.: PCT/US2020/044399

§ 371 Date: Jan. 30, 2023

(51) Int. Cl. H02K 9/22; F04D 29/28; F04D 29/056; F04D 29/58; F04D 29/42; F04D 17/08; H02K 7/00; H02K 7/08; H02K 7/14

(52) U.S. Cl. CPC H02K 9/22; F04D 29/281; F04D 29/056; F04D 29/582; F04D 29/4226; F04D 17/08; H02K 7/003; H02K 7/08; H02K 7/14

(57) ABSTRACT

A rotating machine includes a housing that defines an inlet for air to enter into the rotating machine and an outlet for the air to exit the rotating machine. The rotating machine can also include a bearing received in the housing and a shaft rotationally supported by the bearing. The shaft defines a rotational axis that extends in a longitudinal direction. The rotating machine also includes a fan attached to the shaft so as to be coaxially aligned with the bearing. The fan defines an airflow path including an intake that receives the air from the inlet of the housing and an exhaust that discharges the air from the intake toward the outlet of the housing. A portion of the airflow path between the intake and the exhaust is in a direction that is not parallel to the rotational axis.

### BACKGROUND

Rotating machines, such as starters utilized on an aircraft to start the engine and/or generators that convert rotary motion to electrical energy, are operated at high rotary speed. Operation of these machines can create large amounts of heat that must be removed from the machine for proper operation and increased service life, of the rotating machine, and hence the aircraft.

To remove this heat, fans are many times used. In particular, the fan can force air through the rotating machine. The air that is moved through the rotating machine by the fan absorbs heat from the rotating machine and is subsequently discharged outside of the rotating machine, thereby decreasing the temperature of the rotating machine. However, existing fans to cool rotating machines are deficient.

Notably, many rotating machines rely upon a traditional fan which does not adequately cool the machine. Instead, the traditional fans introduce swirl energy into the air which creases windage losses. This increases the air temperatures and decreases the heat transfer capacity of the air. Furthermore, modern rotating machines are compact and filled with electromagnetics, thereby leaving small spaces for the air to pass through.

As will be appreciated, this increases the resistance faced by the cooling air, thereby slowing down the airflow. Since the convective heat transfer coefficient is directly proportional to the speed of the air going over the surface, this decrease in air speed results in a decrease in total heat transfer. Accordingly, a more advanced rotating machine is needed.

### SUMMARY

In view of the foregoing, a rotating machine includes a housing that defines an inlet for air to enter into the rotating machine and an outlet for the air to exit the rotating machine, a bearing received in the housing, and a shaft rotationally supported by the bearing. The shaft defines a rotational axis that extends in a longitudinal direction. The rotating machine also includes a fan attached to the shaft so as to be coaxially aligned with the bearing.

The fan defines an airflow path including an intake that receives the air from the inlet of the housing and an exhaust that discharges the air from the intake toward the outlet of the housing. A portion of the airflow path between the intake and the exhaust is in a direction that is not parallel to the rotational axis.

### BRIEF DESCRIPTION OF THE DRAWINGS

FIG. 1 is a perspective view of a rotating machine.

FIG. 2A is a sectional elevation view of the rotating machine.

FIG. 2B is a detailed elevation view of the 2B circle of FIG. 2A.

FIG. 3A is a left elevation view of a fan of the rotating machine.

FIG. 3B is a right elevation view of the fan.

FIG. 3C is a front sectional elevation view of the fan of FIG. 3A along lines 3C-3C.

FIG. 4A is a left elevation view of a fan without a shroud of the rotating machine.

FIG. 4B is a right elevation view of the fan of FIG. 4A.

FIG. 4C is a front sectional elevation view of the fan of FIG. 4A along lines 4C-4C.

### DETAILED DESCRIPTION

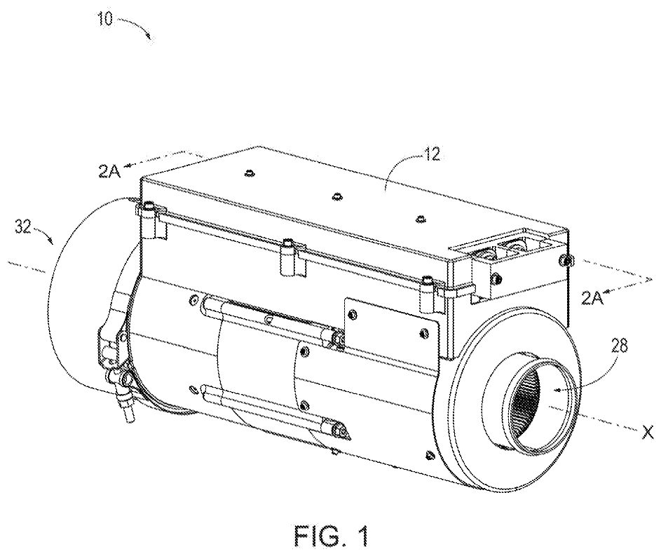

With reference to FIG. 1, a rotating machine 10 is shown. Without departing from the scope of the disclosure, the rotating machine 10 could be an electric motor (e.g., a starter utilized on an aircraft to start the engine) or a generator that converts rotary motion to electrical energy. Alternatively, the rotating machine 10 can be a combination starter-generator that is used to start the engine of an aircraft (i.e., startup mode) and also generate electricity for usage by the aircraft (i.e., generating mode).

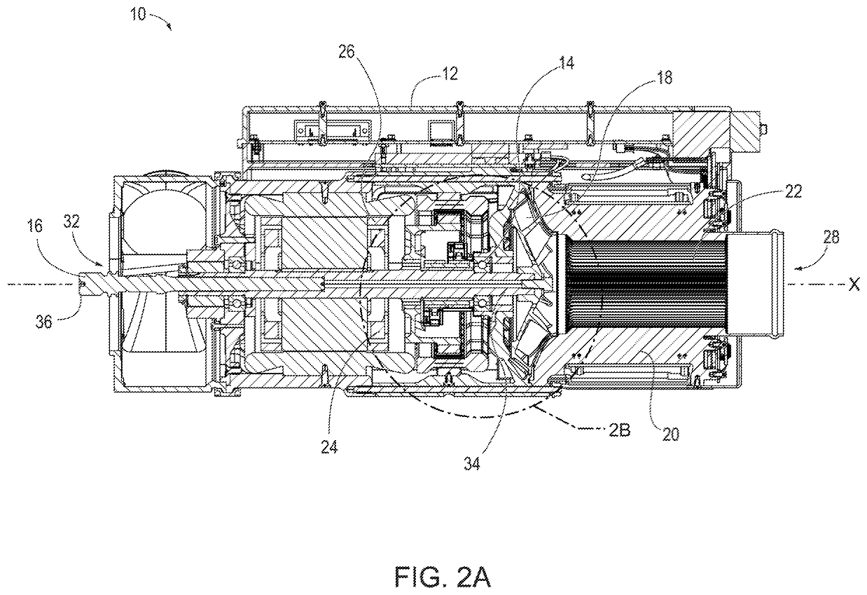

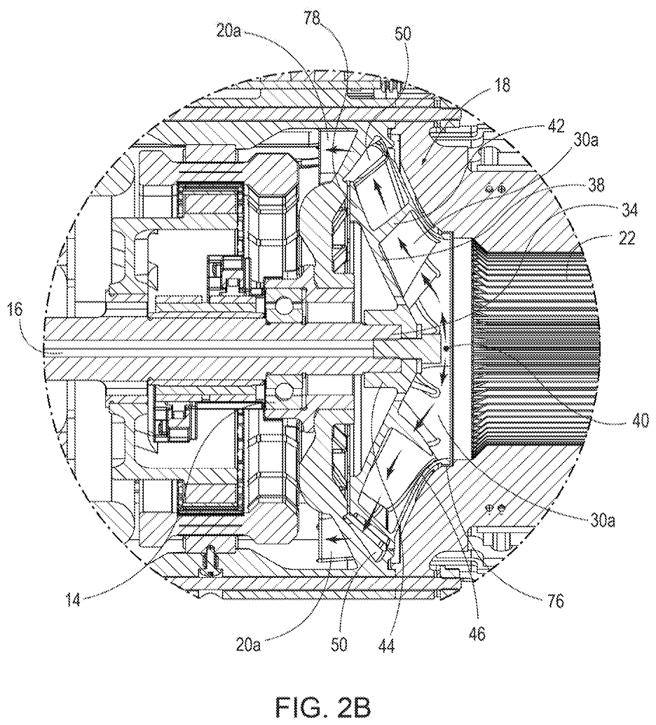

As shown in FIGS. 1-2, the rotating machine 10 includes a housing 12, a bearing 14, a shaft 16, and a fan 18. The rotating machine 10 can also include a heat sink 22, a rotor 24, and a stator 26.

The housing 12 defines an outer surface of the rotating machine 10 and serves to contain the components together in an easily manipulatable package to aid in installation into the aircraft. The housing 12 may be made of any number of materials, including, for example, sheet stock. As illustrated, the housing 12 may be attached to a chassis 20.

The chassis 20 can be made of any number of materials, including for example, aluminum. Aluminum offers good strength, light weight, and high thermal conductivity. The chassis 20 can include a non-rotation section 20a that is downstream of the fan 18. Further, the non-rotation section 20a may be a radial passage that longitudinally extends so as to help redirect the air that leaves the fan 18 in a direction that is parallel to the rotational axis X.

The chassis 20 combines and performs several functions. For example, the chassis 20 serves as a heat sink. Further, the chassis 20 can be a structural part to which parts of the rotating machine 10 can be attached and can also provide an important part of the rotating machine 10 interface with the aircraft. As the chassis 20 is a single component that performs many functions, the size of the rotating machine 10 is kept to a minimum. It is noted that the chassis 20 can be created by additive manufacturing, also known as 3D printing. This allows for the better heat transfer.

Further, the housing 12 defines a cylindrical shape in cross-section in a plane orthogonal to the rotational axis X. The housing 12 defines an inlet 28 for air to enter into the rotating machine 10 and an outlet 32 for the air to exit the rotating machine 10. The inlet 28 and the outlet 32 can be aligned with one another along the rotational axis X.

With continued attention to FIGS. 2A-2B, the rotating machine 10 can include the bearing 14. As illustrated, the rotating machine 10 includes a plurality of bearings 14, although for simplicity, only one is identified. However, it will be understood that any number of bearings 14 could be utilized without departing from the scope of this disclosure. An inner diameter of the bearing is sized and shaped so as to be complimentary with the shaft 16 as will be described in more detail hereinbelow. Further, the bearing 14 may have an outer diameter that is complimentary with the housing 12 so as to be received by the housing 12 and allow rotation of the inner diameter of the bearing 14 with respect to the housing 12 as is known.

The rotating machine 10 also includes the shaft 16 that is rotatably disposed at least partially within the housing 12. The shaft 16 includes a first longitudinal end 34 and a second longitudinal end 36. The shaft 16 defines a rotational axis X that extends in a longitudinal direction. Further, the shaft 16 can be circular in cross-section in a plane orthogonal to the rotational axis X. The shaft 16 may be supported by the bearing 14. The shaft 16 can be made of any number of materials that provide sufficient strength and rigidity to support the fan 18 and the rotor 24 as will be described in more detail hereinafter.

As shown in FIGS. 2A-2B, the fan 18 is attached to the shaft 16 and can be coaxially aligned with the bearing 14. Further, the fan 18 is configured to move the air from the inlet 28 to the outlet 32 such that the air leaving the fan 18 does not travel in a path that is always parallel to the rotational axis X.

As illustrated, the fan 18 is disposed at the first longitudinal end 34 of the shaft 16. The fan 18 may be made of any number of materials that offer sufficient strength and rigidity, along with appropriate chemical resistance to segregation, including for example, aluminum, plastic, and fiber-reinforced plastic. The fan 18 can also be created by additive manufacturing, also known as 3D printing.

Notably, the fan 18 defines an airflow path 30 including an intake 40 that receives the air from the inlet 28 of the housing 12 and an exhaust 50 that discharges the air from the intake 40 toward the outlet of the housing 12. As illustrated, a portion 30a of the airflow path 30 between the intake 40 and the exhaust 50 is in a direction that is not parallel to the rotational axis X.

Rather, in a sectional view, as shown in FIG. 2B, the portion 30a extends in a direction that is nearly perpendicular to the rotational axis X. In particular, the fan 18 changes the direction of the airflow from the inlet 28, which arrives at the intake 40 in a direction that is parallel to the rotational axis X to a radially extending outward direction (vertical in the sectional view of FIG. 2B) in the portion 30a.

Although the exhaust 50 is merely illustrated in two locations in FIG. 28, it will be understood that this is a function of the drawing being a sectional 2-D representation, Notably, the exhaust 50 is a region that serves as the exit point for the air that was in the fan 18. The exhaust 50 is a void of material in a ring shape extending around a perimeter of the fan 18 from which the air that has passed through the fan 18 is discharged. Similarly, the intake 40 is defined as the region that serves as the entry point for air from the inlet 28 into the fan 18.

The air from the inlet 28 that enters the fan 18 may exclusively enter the fan 18 through the intake 40 and exit the fan 18 through the exhaust 50. Thus, the fan 18 is configured to receive the air from the inlet 28 in a direction that is parallel to the rotational axis X and, in cooperation with the non-rotation section 20a of the chassis 20, subsequently discharge the air from the fan 18 toward the outlet 32 such that the discharged air is then again parallel to the rotational axis X.

Then, the fan 18 changes the airflow direction again after leaving the exhaust 50 to a direction that is once again generally parallel to the rotational axis X. The aforementioned changes in airflow direction offer numerous thermodynamic cooling advantages to the rotating machine 10. In particular, a minimum of swirl energy is imparted into the air, thereby minimizing windage losses. As such, the heat transfer capacity of the air is improved.

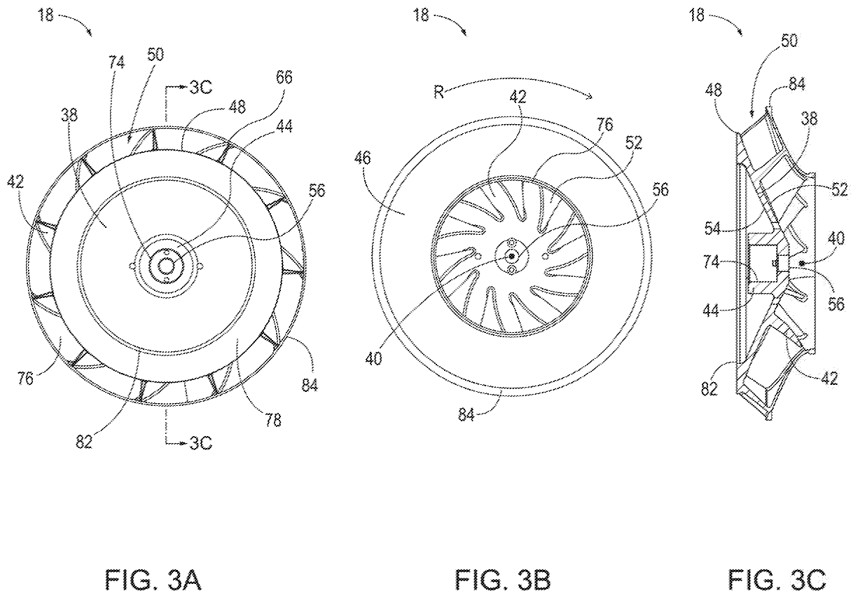

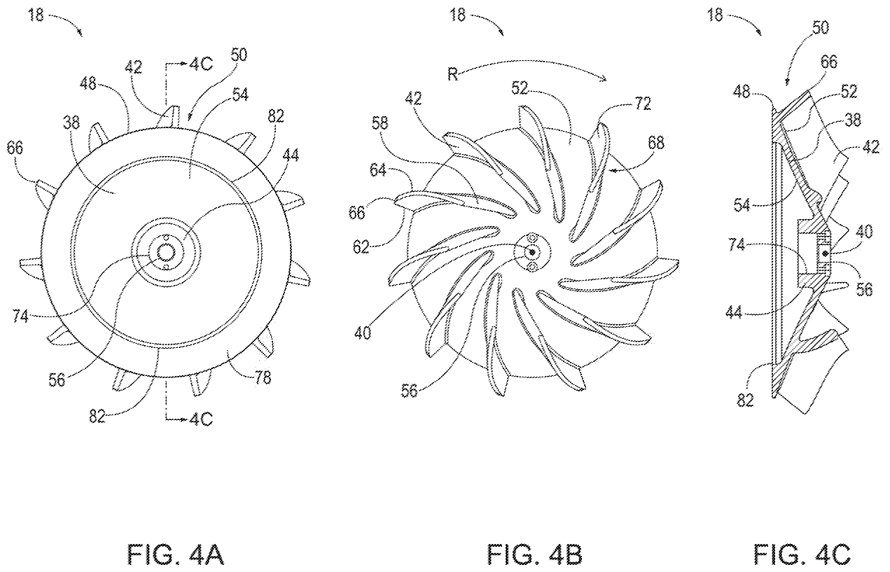

With specific attention to FIGS. 3A-4B, the fan 18 is shown in more detail. The fan 18 is attached to the shaft 16 so that rotation of the shaft 16 about the rotational axis X results in rotation of the fan 18. The fan 18 can include a curved back plate 38 that defines a frusto-conical shape and a plurality of impeller blades 42, and a hub 44. The back plate 38 and the plurality of impeller blades 42 cooperate to define the airflow path 30 from the intake 40 to the exhaust 50.

As shown in FIGS. 36 and 46, the fan 18 can have 11 impeller blades 42. This number of blades can provide the proper amount and speed of airflow so as to sufficiently cool the components within the housing 12. Because of the back plate 38 and the plurality of impeller blades 42, the fan 18 outputs an air pressure that is higher than axial fans and lower than centrifugal fans. This mid-pressure output allows the discharged air to overcome flow obstructions when traveling from the fan 18 to the outlet 32.

Further, the fan 18 can include a shroud 46. Notably, FIGS. 3A-36 illustrate the fan 18 with a shroud 46 that is integral, whereas FIGS. 4A-413 illustrate the fan 18 without the shroud 46. It will be understood that the fan 18 does not require the shroud 46, but numerous operating advantages are provided by the shroud 46 as will be discussed in more detail hereinafter.

The shroud 46 can be integral to the fan 18. With the shroud 46 being integral to the fan 18, numerous advantages are provided. For example, weight savings are realized and improved performance of the fan 18 (e.g., higher flow rate) is achieved. The shroud 46 reduces complexity and part count and eliminates interface problems which could occur with multiple parts that perform the same functions. Having the shroud 46 as one part also makes it easier to optimize the airflow as there are no fasteners or part interfaces which might disrupt the airflow. As will be appreciated, this is extremely desirable in an aircraft.

Further, the shroud 46 is disposed so as to be upstream of the bearing 14 and downstream of the inlet 28 so as to at least partially cover the plurality of impeller blades 42. The shroud 46 cooperates with the plurality of impeller blades 42 and the housing 12 to move the air from the inlet 28 to the outlet 32.

The back plate 38 defines an outer diameter 48 and includes an upstream face 52 that faces the inlet 28 and a downstream face 54 that faces the outlet 32. The upstream face 52 and the downstream face 54 face in opposite directions to one another along the rotational axis X. Further, the back plate 38 defines a bore 56 that extends through the upstream face 52 and the downstream face 54 to allow receipt of the shaft 16. The bore 56 can be aligned with the rotational axis X.

Additionally, the back plate 38 can extend radially outward from the bore 56 so as to provide a continuous surface between each of the plurality of impeller blades 42 so as to prevent the air from longitudinally traveling between individual blades of the plurality of impeller blades 42. This arrangement ensures that the air can sufficiently cool the rotor 24 and the stator 26.

The plurality of impeller blades 42 extend from the upstream face 52 in a direction away from the outlet 32 of the housing 12. Further, the plurality of impeller blades 42 radially extend from the outer diameter 48 of the back plate 38 along the upstream face 52 toward the bore 56 in a curved manner when viewing the back plate 38 along the rotational axis X. Additionally, each of the plurality of impeller blades 42 can directly contact the back plate 38 and the shroud 46. As illustrated, the plurality of impeller blades 42 each extend between the back plate 38 and the shroud 46 so as to space the back plate 38 and the shroud 46 from one another.

Each of the blades 42 can include an inner curved radial surface 58 and an outer flat radial surface 62, The inner curved radial surface 58 and the outer flat radial surface 62 are connected by a free end flat face 64. The free end flat face 64 faces away from the outlet 32. Further, the outer flat radial surface 62 and the free end flat face 64 meet to define an outermost point 66 that is a first radial distance from the rotational axis X. Notably, the first radial distance is greater than a radial distance between the rotational axis X and the outer diameter 48 of the back plate 38. The inner curved radial surface and the outer flat radial surface cooperate to define a radial length of each of the plurality of impeller blades 42.

Each of the blades 42 can also include a leading face 68 and a trailing face 72. The leading face 68 and the trailing face 72 cooperate to define an angular thickness of each of the plurality of impeller blades. As illustrated, each of the blades 42 has the same thickness. Notably, the radial length of each of the plurality of impeller blades 42 is greater than the angular thickness of each of the plurality of impeller blades 42. The aforementioned design of the blades 42 provides numerous advantages. For example, the tensile stress subjected to the fan 18 due to rotation loads is reduced, aerodynamic performance is improved, and noise during operation is reduced.

The hub 44 of the fan 18 extends from the downstream face 54 of the back plate 38 toward the outlet 32 of the housing 12. Further, the hub 44 defines a hole 74 for receipt of the shaft 16. As will be appreciated, the hole 74 is sized so as to allow for passage of the shaft 16. The hole 74 and the bore 56 can be in registry so as to allow passage of the shaft 16 therethrough.

The shroud 46 defines an opening 76 that allows fluid communication between the plurality of impeller blades 42 and the inlet 28. When the fan 18 of the rotating machine 10 includes the shroud 46, the intake 40 is disposed immediately upstream and adjacent the plurality of the impeller blades 42 and immediately downstream and adjacent the opening 76 of the shroud 46. When the fan 18 does not include the shroud 46, the intake 40 is in the same location, namely immediately adjacent and upstream of the impeller blades 42.

As illustrated, the, opening 76 is circular in shape and coaxially aligned with the rotational axis X. Further, the opening 76 of the shroud 46 defines a shroud opening diameter that is greater than the bore 56 of the back plate 38. Further, the shroud 46 defines a shroud outer diameter 84. The shroud outer diameter 84 is greater than the outer diameter 48 of the back plate 38, The aforementioned geometric differences help ensure proper movement of the air between the inlet 28 and the outlet 32.

The fan 18 can also include a sealing ring portion 78. As illustrated, the sealing ring portion 78 is integral to the fan 18 and to the back plate 38. The sealing ring portion 78 can be generally circular in shape and ex-tend from the downstream face 54 of the back plate 38 toward the outlet 32. The sealing ring portion 78 and the plurality of blades 42 are on opposite longitudinal sides of the back plate 38. The sealing ring portion 78 defines an inner diameter 82 which is greater than the opening 76 of the shroud 46.

With reference once again to FIG. 2A, the heat sink 22 is shown. The heat sink 22 allows for cooling of adjacent electrical/electronic components (unnumbered) due to the air that enters through the inlet 28. The heat sink 22 can be disposed within the housing 12 so as to be between the fan 18 and the inlet 28. Furthermore, this location can be coaxially aligned with the fan 18 and the inlet 28.

With continued attention to FIG. 2A, the rotating machine 10 also includes the rotor 24, which is attached or coupled to the shaft 16 so that the shaft 16 and the rotor 24 rotate together. The rotor 24 is of known construction. Rotation of the rotor 24 is due to the interaction between the windings and magnetic fields which produces a torque around the rotational axis X. The rotor 24 is rotationally movable with respect to the stator 26. The rotor 24 is disposed on the shaft 16 so as to be between the heat sink 22 and the outlet 32. Additionally, the rotor 24 is received on the shaft 16 such that the fan 18 is longitudinally disposed between the rotor 24 and the inlet 28.

The stator 26 is of known construction. The stator 26 is a stationary part of the rotating machine 10, and thus is stationary with respect to the housing 12 and the rotor 24. When the rotating machine 10 is a generator, energy flows through the stator 26 to or from the rotor 24 as is known. When the rotating machine 10 is a starter, the stator 26 provides a rotating magnetic field that drives the rotating armature, as is also known in the art. When the rotating machine 10 is a generator, the stator 26 converts the rotating magnetic field to electric current. The stator 26 is disposed within the housing 12.

A rotating machine has been described above with particularity. Modifications and alterations will occur to those upon reading and understanding the preceding detailed description. The invention, however, is not limited to only the embodiments described above. Instead, the invention is broadly defined by the appended claims and the equivalents thereof.

1. A rotating machine, comprising:
a housing defining an inlet for air to e into the rotating machine and an outlet for the air to exit the rotating machine;
a bearing received in the housing;
a shaft rotationally supported by the bearing, the shaft defining a rotational axis that extends in a longitudinal direction; and
a fan attached to the shaft so as to be coaxially aligned with the bearing, wherein the fan defines an airflow path including an intake that receives the air from the inlet of the housing and an exhaust that discharges the air from the intake toward the outlet of the housing, and wherein a portion of the airflow path between the intake and the exhaust is in a direction that is not parallel to the rotational axis.

2. The rotating machine of claim 1, wherein the inlet and the outlet are aligned with one another along the rotational axis, and wherein the air from the inlet that enters the fan exclusively enters the fan through the intake and exits the fan through the exhaust.

3. The rotating machine of claim 2, further comprising;
a heat sink disposed within the housing so as to be longitudinally between the fan and the inlet; and
a rotor disposed on the shaft so as to be longitudinally between the heat sink and the outlet, wherein the fan is configured to receive the air from the inlet iii a direction that is parallel to the rotational axis and in cooperation with a non-rotation section of a chassis, subsequently discharge the air from the fan toward the outlet such that the discharged air is then again parallel to the rotational axis.

4. The rotating machine of claim 1, wherein the fan includes curved back plate with an upstream face that faces the inlet and a downstream face that faces the outlet, and wherein the upstream face and the downstream face face in opposite directions to one another along the rotational axis.

5. The rotating machine of claim 4, wherein the fan includes a plurality of impeller blades extending from the upstream face in a direction away from the outlet of the housing.

6. The rotating machine of claim 5, wherein the fan includes a hub that extends from the downstream face of the back plate toward, the outlet of the housing, and wherein the hub defines a hole for receipt of the shaft.

7. The rotating machine of claim 6, wherein the back plate defines a bore that is in registry with the hole of the hub so as to allow passage of the shaft therethrough.

8. The rotating machine of claim 7, wherein the back plate is curved so as to define a frusta-conical shape, and wherein the back plate defines an outer diameter from which the plurality of impeller blades radially extend along the upstream face toward the bore in a curved manner when viewing the back plate along the rotational axis.

9. The rotating machine of claim 7, wherein the back plate radially extends outward from the bore so as to provide a continuous surface between each of the plurality of impeller blades so as to prevent the air from longitudinally traveling between individual blades of the plurality of impeller blades.

10. The rotating machine of claim 5, the fan further comprising a shroud that is integral to the fan, wherein the shroud is upstream of the bearing and downstream of the inlet so as to at least partially cover the plurality of impeller blades, wherein the back plate and the plurality of impeller blades cooperate to define the airflow path from the intake to the exhaust.

11. The rotating machine of claim 10, wherein the shroud defines a shroud outer diameter that is greater than an outer diameter of the back plate.

12. The rotating machine of claim 10, wherein the shroud defines an opening that allows fluid communication between the plurality of impeller blades and the inlet.

13. The rotating machine of claim 12, wherein the opening of the shroud defines a shroud opening diameter that is greater than a bore of the back plate.

14. The rotating machine of claim 10, wherein the plurality of impeller blades each extend between the back plate and the shroud so as to space the back plate and the shroud from one another, and wherein each of the plurality of impeller blades directly contacts the back plate and the shroud.

15. The rotating machine of claim 5, wherein the plurality of impeller blades each include an inner curved radial surface and an outer flat radial surface that are connected by a free end flat face that faces away from the outlet, wherein the outer flat radial surface and the free end flat face meet to define an outermost point that is a first radial distance from the rotational axis, and wherein the first radial distance is greater than a radial distance between the rotational axis and an outer diameter of the back plate.

16. The rotating machine of claim 15, wherein the plurality of impeller blades each include leading face and a trailing face that cooperate to define an angular thickness of each of the plurality of impeller blades, wherein the inner curved radial surface and the outer flat radial surface cooperate to define a radial length of each of the plurality of impeller blades, and wherein the radial length of each of the plurality of impeller blades is greater than the angular thickness of each of the plurality of impeller blades.

17. The rotating machine of claim 5, wherein the fan includes a sealing ring portion, and wherein the sealing ring portion and the plurality of blades are on opposite longitudinal sides of the back plate.

18. The rotating machine of claim 17, the fan further comprising a shroud that cooperates with the plurality of impeller blades and the housing to move the air from the inlet to the outlet.

19. The rotating machine of claim 18, wherein the shroud defines an opening that allows fluid communication between the plurality of impeller blades and the inlet of the housing, and wherein the sealing ring portion defines an inner diameter that is greater than the opening of the shroud.

20. The rotating machine of claim 10, further including a rotor received on the shaft such that the fan is longitudinally disposed between the rotor and the inlet, wherein the fan is disposed at a longitudinal end of the shaft such that the plurality of impeller blades extend away from the rotor.
